(19) United States
(12) Patent Application Publication
(10) Pub. No.: US 2009/0225812 A1
(43) Pub. Date: Sep. 10, 2009

(54) Method and System for Detecting Code Sequences in Ultra-Wideband Systems

(76) Inventors: Po Shin Francois Chin, Singapore (SG); Xiaoming Peng, Singapore (SG)

Correspondence Address: CROCKETT & CROCKETT, P.C., 26020 ACERO, SUITE 200, MISSION VIEJO, CA, 92691, US

(21) Appl. No.: 11/908,755

(22) PCT Filed: Mar. 14, 2006
(86) PCT No.: PCT/SG2006/000056

§ 371 Date: Jun. 23, 2008

Related U.S. Application Data
(60) Provisional application No. 60/662,258, filed on Mar. 16, 2005.
(60) Provisional application No. 60/662,257, filed on Mar. 16, 2005.

(51) Int. Cl. H04B 1/00

(52) U.S. Cl. 375/138; 375/147; 375/E01.032

(57) ABSTRACT

A method and a system are provided for detecting a code sequence in an ultra-wideband system. An on-off keying (OOK) detector is used for detecting a code sequence. A soft despreader is used for despreading the energy of the code sequence to provide a plurality of multipath energies. A RAKE combiner combines the plurality of multipath energies obtained from the soft despreader. The soft despreader and the RAKE combiner enable operation of an OOK receiver without using a timing recovery process block.

### CROSS REFERENCE TO RELATED APPLICATIONS

This application claims the benefit of priority of U.S. provisional application No. 60/662,257, filed Mar. 16, 2005 and U.S. provisional application No. 60/662,258, filed Mar. 16, 2005, the contents of each being hereby incorporated by reference in its entirety for all purposes.

### FIELD OF THE INVENTION

The invention relates, in general, to detecting code sequences in wireless communication, and in particular, to a method and a system for detecting code sequences in an ultra-wideband (UWB) system.

### BACKGROUND OF THE INVENTION

To detect energy in an on-off keying (OOK) system, it is conventional to integrate, sample, and set a threshold to make a decision. A timing recovery process block is required in order to find the starting point of integration. There are two types of timing recovery blocks: an analog timing recovery block and a digital timing recovery block. The analog timing recovery block includes a loop filter and a voltage control oscillator (VCO) and some other circuits that are relatively expensive to implement in the receiver. The digital timing recovery block includes a loop filter and adjustable clock blocks that are also relatively expensive to implement. In low cost and low power consumption UWB applications, it would be advantageous if a timing recovery block did not have to be implemented.

### SUMMARY OF THE INVENTION

A method and a system are provided for detecting a code sequence in an ultra-wideband system. An on-off keying (OOK) detector is used for detecting a code sequence. A soft despreader is used for despreading the energy of the code sequence to provide a plurality of multipath energies. A RAKE combiner combines the plurality of multipath energies obtained from the soft despreader.

Because a binary sequence soft despreader and a RAKE combiner are used, a costly timing recovery process is not required. The binary sequence soft despreader and the RAKE combiner also provide a multipath diversity gain enabling an OOK receiver to handle inter-pulse interference.

### BRIEF DESCRIPTION OF THE DRAWINGS

FIG. 1 is a diagram showing examples of received code sequences;

FIG. 2 is a schematic diagram of a receiver;

FIG. 3 is a graph for illustrating integration with inter-pulse interference under a multipath scenario;

FIG. 4 is a table showing the chip sequence after integration and sampling;

FIG. 5 is three tables showing the output sequence of each rake finger after processing by the binary sequence soft despreader;

FIG. 6 is a graph for illustrating integration with inter-pulse interference under a multipath scenario without using a timing recovery block;

FIG. 7 is a table showing the chip sequence after integrating and sampling without using a timing recovery block;

FIG. 8 is three tables showing the output sequence of each rake finger after processing by the binary sequence soft despreader and without using a timing recovery block;

FIG. 9 is a block diagram showing the steps of a method for constructing a set of 2^{K} orthogonal N-chip ternary transmission sequences to represent a K-bit symbol;

FIG. 10 is a block diagram showing the steps of a method for constructing a set of 2^{K} orthogonal N-chip bipolar sequences to represent a K-bit symbol; and

FIG. 11 is a block diagram showing the steps of a method for converting a set of 2^{k} orthogonal N-chip ternary sequences to a set of 2^{k} orthogonal N-chip bipolar sequences.

### DESCRIPTION OF THE PREFERRED EMBODIMENTS

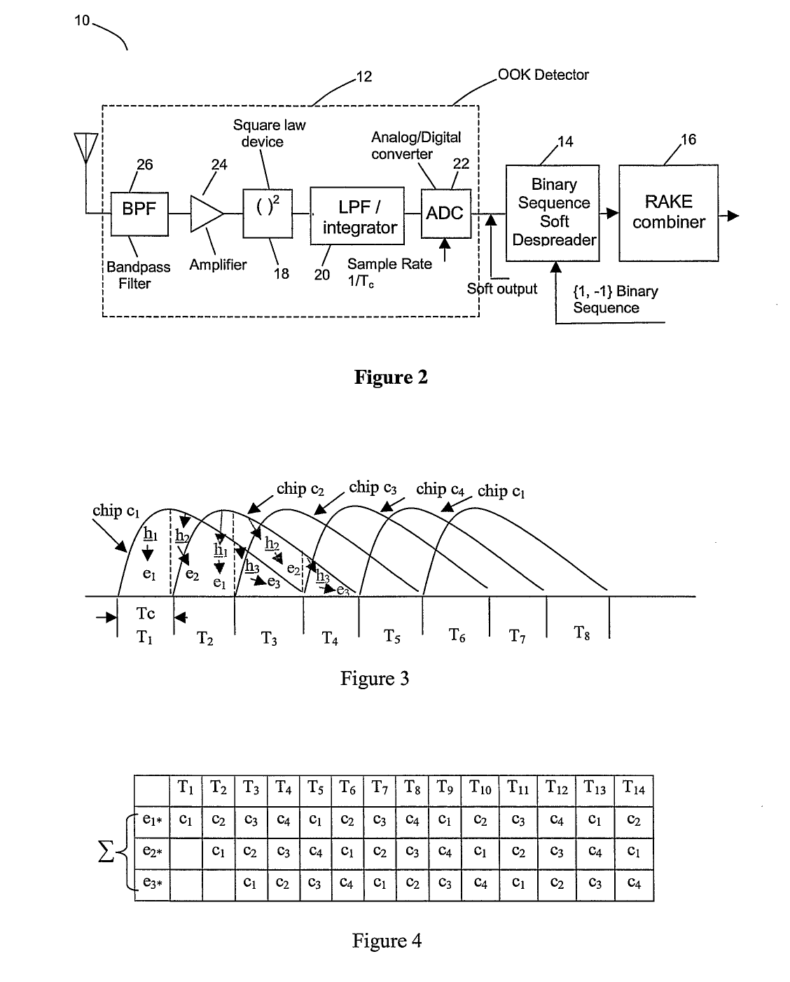

FIG. 2 shows an example of an on-off keying OOK receiver 10 constructed for performing a non-coherent energy detection method. The OOK receiver 10 includes an on-off keying (OOK) detector that is preferably constructed as a non-conherent on-off keying (OOK) detector 12 for detecting the energy of a received code sequence. The OOK receiver 10 also includes a soft despreader that is preferably constructed as a binary sequence soft despreader 14 using a binary sequence for despreading the soft energy value provided at the output of the OOK detector 12. Additionally, the OOK receiver 10 includes a RAKE combiner 16 for combining the multi-path energy components.

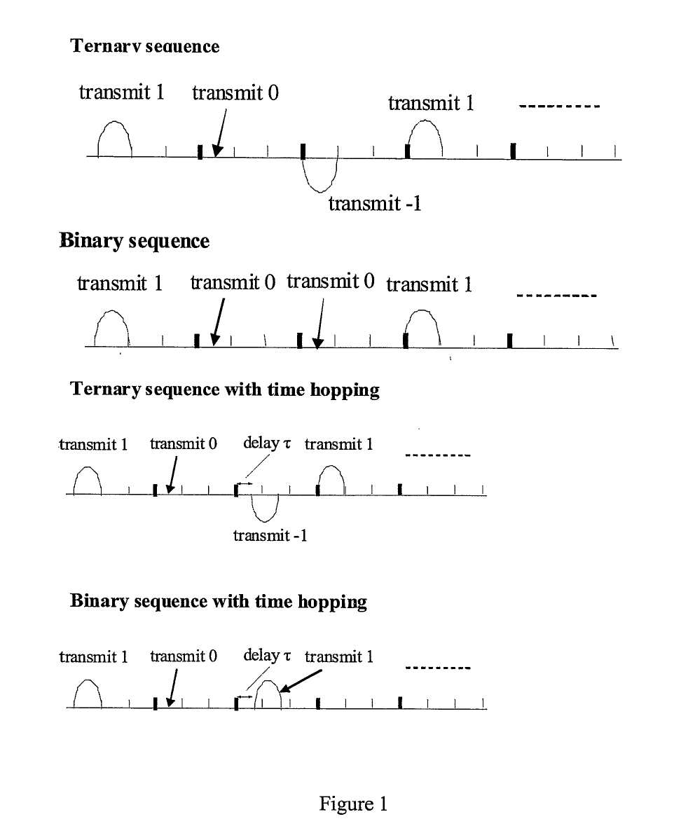

The non-coherent energy detection method explained below can be used for detecting the energy of a received code sequence. Examples of code sequences that could be received include those shown in FIG. 1. FIG. 1 shows a ternary code sequence, a binary code sequence, a ternary sequence with time hopping, and a binary sequence with time hopping.

The non-coherent OOK detector 12 uses multipath diversity to alleviate performance degradation due to the inter-pulse interference. FIG. 3 illustrates the integration with the inter-pulse interference under a multipath scenario. In this example, the length of the code sequence is four. The multipath is assumed to diminish across three sampling periods where Tc is the sampling period. The channel impulse responses for one chip are represented as h₁, h₂, h₃ respectively in each sampling period.

The non-coherent OOK detector 12 includes an amplifier 24, a square law device 18, an integrator 20 with a low pass filter LPF, and an analog to digital converter 22 (ADC). These blocks are conventionally used in an OOK receiver. By using the detected energy, each chip (c₁, c₂, c₃, c₄), convolves with the channel impulse responses and passes through the square law device 18 followed by the integrator 20 and the analog to digital converter 22 (ADC).

In general, a conventional OOK receiver is only able to handle received code sequences without inter-pulse interference. FIG. 3 illustrates such a case, considering inter-pulse interference due to a small duty cycle between consecutive pulses. Equivalently, the operation of a square law device, integrator, and ADC blocks can be modeled as follows:

rₒ=∫|c*(h₁+h₂+h₃)+n|²=∫|c*(h₁+h₂+h₃)|²+η=c*∫(|h₁|²+|h₂|³+|h₃|²)+ζ (1)

where:
rₒ is the output of ADC, it is a binary sequence with soft value due to the square law device;
n is Additive White Gaussian Noise (AWGN);
η and ζ are corresponding terms of combined noise and inter-pulse interference; and
* denotes convolution.
   This expression can be further simplified as:

$$\begin{matrix}{r}_{o} = {c}^{*} ( {\int }_{0}^{{T}_{c}} {\vert {\underline{h}}_{1} \vert}^{2} d t + {\int }_{0}^{{T}_{c}} {\vert {\underline{h}}_{2} \vert}^{2} d t + {\int }_{0}^{{T}_{c}} {\vert {\underline{h}}_{3} \vert}^{2} d t + ζ \\ = {c}^{*} ( {e}_{1} + {e}_{2} + {e}_{3} )\end{matrix} \\ where \text{:} \\ {e}_{1} = {\int }_{0}^{{T}_{c}} {\vert {\underline{h}}_{1} \vert}^{2} d t , {e}_{2} = {\int }_{0}^{{T}_{c}} {\vert {\underline{h}}_{2} \vert}^{2} d t , {e}_{3} = {\int }_{0}^{{T}_{c}} {\vert {\underline{h}}_{3} \vert}^{2} d t ; \qquad ( 2 )$$

e₁ is the energy captured by the integration in the first Tc period for each chip;
e₂ is the energy captured by the integration in the second Tc period for each chip; and
e₃ is the energy captured by the integration in the third Tc period for each chip.

FIG. 4 shows the chip sequence after the integration and sampling. In T₁, the output of rₒ only consists of the convolution of c₁ and e₁. In T₂, the output of rₒ consists of the sum of the convolution of c₂ and e₁ and the convolution of c₁ and e₂. In T₃, the output of rₒ consists of the sum of the convolution of c₃ and e₁, the convolution of c₂ and e₂, and the convolution of c₁ and e₃ In T₄, the output of rₒ consists of the sum of the convolution of c₄ and e₁, the convolution of c₃ and e₂, and the convolution of c₂ and e₃. The same rule shown in FIG. 4 is followed for the subsequent cycle of the code sequence.

For a given received code sequence, for example, a ternary code sequence set having {0,+1,−1}, the received ternary code sequence set is transformed into a binary code sequence set {1,0} after passing through the square law device 18, the integrator 20, and the analog-to-digital converter 22.

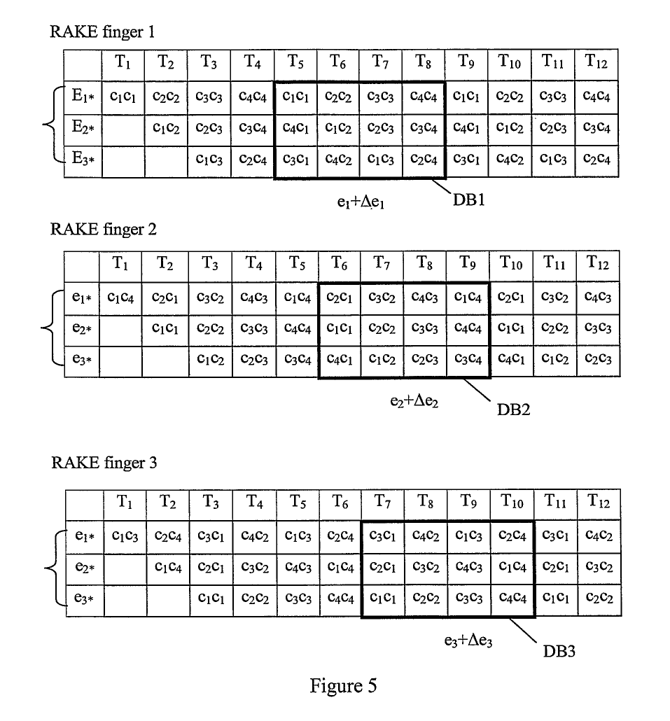

FIG. 5 shows the output sequence of each RAKE finger after being processed by the binary sequence binary sequence soft despreader 14. Three RAKE fingers have been considered in this illustration. It is seen that for RAKE finger 1, the binary sequence soft despreader 14 starts from T₁. Code sequences c₁, c₂, c₃ and c₄ are subsequently multiplied with the output rₒ in each Tc. For RAKE finger 2, the binary sequence soft despreader 14 starts from T₂ because there is a Tc delay. Code sequences c₁, c₂, c₃ and c₄ are subsequently multiplied with the output rₒ in each Tc. Similarly, for RAKE finger 3, the binary sequence soft despreader 14 starts from T₃ because there is an additional Tc delay. Code sequences c₁, c₂, c₃ and c₄ are subsequently multiplied with the output rₒ in each Tc. The darkened boxes (DB1, DB2, DB3) shown in FIG. 5 depict the binary sequence soft despreader 14 for each RAKE finger within the length of the code sequence. It is seen that for RAKE finger 1, from T₅ to T₈, due to the multipath, there is inter-pulse interference. However, because of the property of the orthogonal binary code sequence, the cross-correlation of c₄c₁+c₁c₂+c₂c₃+c₃c₄ and c₃c₁+c₄c₂+c₁c₃+c₂c₄ are very small which results in smaller inter-pulse interference. Therefore, the output of RAKE finger 1 is e₁+Δe₁, where Δe₁ is the inter-pulse interference. Similarly, for RAKE fingers 2 and 3, the output is e₂+Δe₂, e₃+Δe₃ respectively. The purpose of the RAKE combiner 16 is to combine the plurality of multipath energies collected after processing by the binary sequence soft despreader 14. In this example, the RAKE combiner 16 combines the output of these three RAKE fingers to achieve diversity gain. In an implementation, the number of RAKE fingers is chosen to achieve a trade-off between performance and complexity. The number of RAKE fingers used is less than the number of sampling periods, which is determined by the channel delay spread.

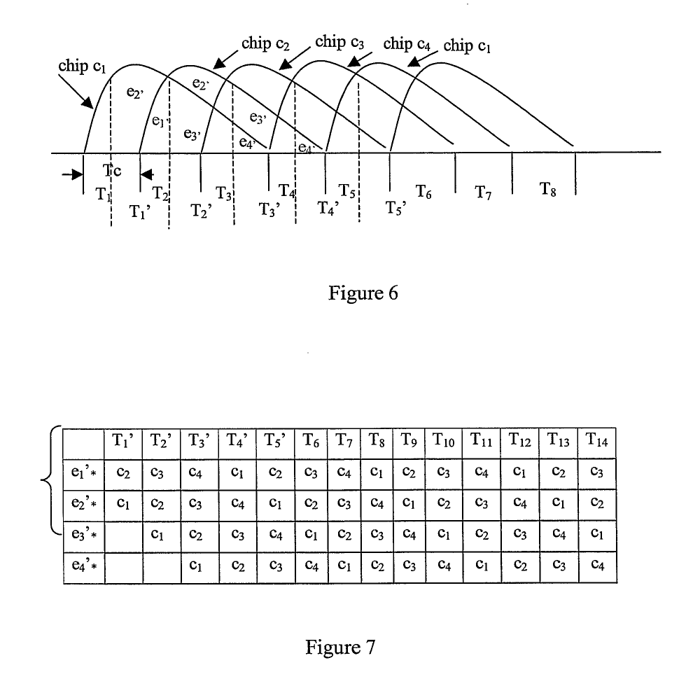

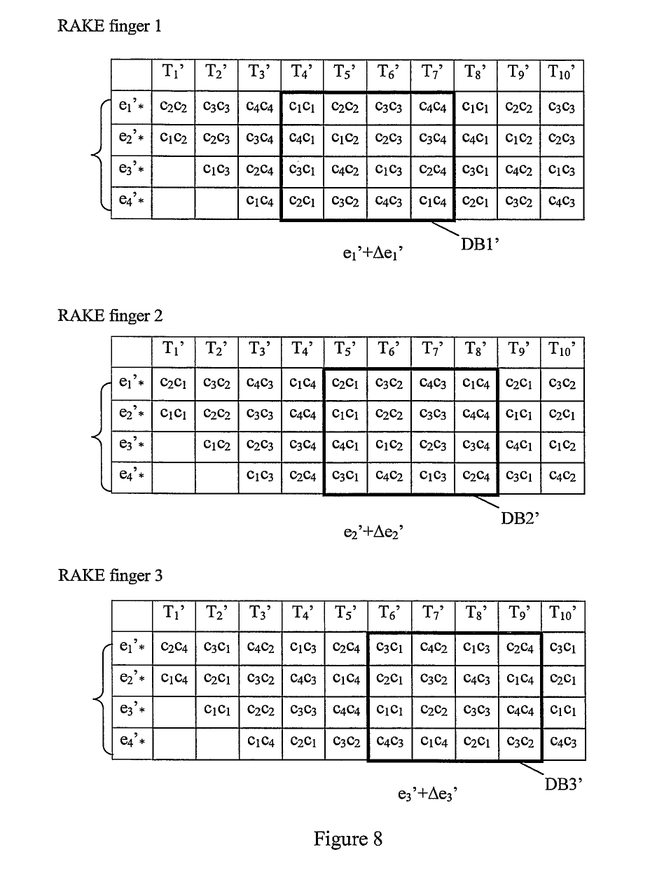

FIG. 6 illustrates an integration with inter-pulse interference under a multipath scenario without using a timing recovery block. The time index from T₁ to T₈ is for the case with timing recovery information as a reference. The time index from T₁′ to T₈′ is for the case without using timing recovery information. The starting point is randomly chosen. Similarly to the aforementioned equivalent method, the energy captured for each chip can be divided into e₁′, e₂′, e₃′, and e₄′, rather than into only three parts, like e₁, e₂, e₃. At the receiver, three RAKE fingers will be used to collect energy. In each RAKE finger, the binary sequence soft despreader 14 is applied in the same manner as aforementioned. The only difference is that the inter-pulse interference due to the cross correlation among the orthogonal binary sequence will be increased. In this example, it is increased to 4. After the binary sequence soft despreader 14, each RAKE finger can collect the desired energy with a certain inter-pulse interference. The amount of inter-pulse interference is determined by the cross correlation properties. FIG. 8 shows the output sequence of each rake finger after processing by the binary sequence soft despreader 14 and without using a timing recovery block. The darkened boxes (DB1′, DB2′, DB3′) depict the binary sequence soft despreader 14 for each RAKE finger within the length of the code sequence. Following that, the energy from three RAKE fingers can be combined together to achieve multipath diversity gain. It is found that the sum of e₁′, e₂′, e₃′ is smaller than the sum of e₁, e₂, e₃. This implies that, in this example, the diversity gain that is obtained without using a timing recovery process block is less than when using a timing recovery block.

Including the binary sequence soft despreader 14 and the RAKE combiner 16 allows the OOK receiver 10 to work without using a timing recovery process block. As has been previously explained, such a timing recovery process block is relatively expensive to implement. Using the binary sequence soft despreader 14 and the RAKE combiner 16 provides a multipath diversity gain enabling the OOK receiver 10 to handle inter-pulse interference.

Examples of useful methods for constructing orthogonal code sequences in ultra wideband (UWB) systems will now be described. These methods may be of use when implementing the invention, however, it should be understood that conventional methods may also be used. The choice of an appropriate method for constructing orthogonal code sequences depends upon the requirements of a particular implementation.

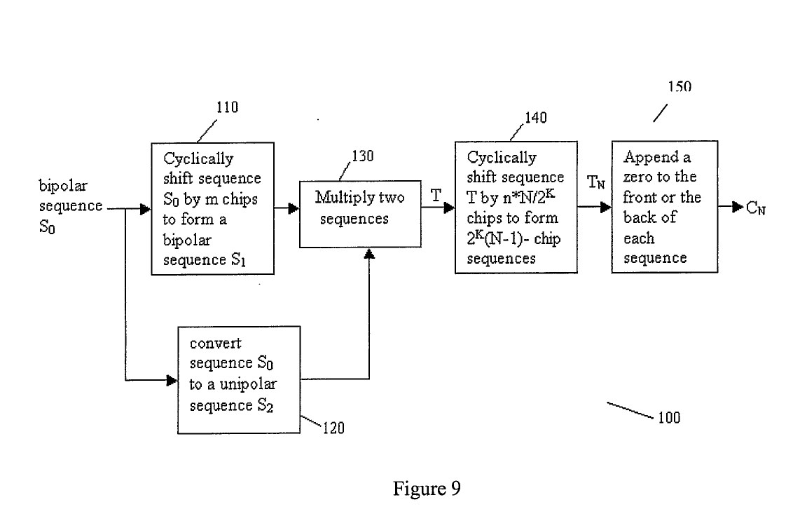

FIG. 9 is a block diagram showing the steps of a method 100 for constructing a set of 2^{K} orthogonal N-chip ternary transmission sequences to represent a K-bit symbol. First, an (N−1)-chip bipolar base sequence S₀ is chosen. The (N−1)-chip bipolar base sequence S₀ is an M-sequence with a sequence sum equal to 1. The M-sequence is a Maximum-Length Shift-Register Sequence. In step 110, the bipolar base sequence S₀ is cyclically shifted by m chips to form an (N−1)-chip bipolar sequence S₁. Here, m ranges from 2 to N-2. In step 120, the bipolar base sequence S₀ is converted to form a unipolar sequence S₂ by changing −1 to 0. In step 130, the bipolar sequence S₁ and the unipolar sequence S₂ are multiplied together to form a ternary sequence T including {0,+1,−1} chips. In step 140, the ternary sequence T is cyclically shifted by n*N/2^{K} chips to form 2^{K} (N−1)-chip ternary sequences Tₙ, where n=1, 2, . . . , 2^{K}. In step 150, a zero is appended to the front or to the back of each Tₙ to form the required 2^{K} N-chip ternary sequences Cₙ, where n=1, 2, . . . , 2^{K}.

In the example given below, the method 100 is implemented using the chosen bipolar base sequence S₀. The resulting bipolar sequence S₁, unipolar sequence S₂, ternary sequences Tₙ, and ternary sequences Cₙ are shown when K=2 and N=32.

$${S}_{0} = [ \begin{matrix}1 & 1 & 1 & - 1 & - 1 & - 1 & 1 & 1 & - 1 & 1 \\ 1 & 1 & - 1 & 1 & - 1 & 1 & - 1 & - 1 & - 1 & - 1 \\ 1 & - 1 & - 1 & 1 & - 1 & 1 & 1 & - 1 & - 1 & 1 \; 1\end{matrix} ]$$

$$M = 16$$

$${S}_{1} = [ \begin{matrix}1 & - 1 & - 1 & - 1 & - 1 & 1 & - 1 & - 1 & 1 & - 1 & \\ 1 & 1 & - 1 & - 1 & 1 & 1 & 1 & 1 & 1 & - 1 & \\ - 1 & - 1 & 1 & 1 & - 1 & 1 & 1 & 1 & - 1 & 1 & - 1\end{matrix} ]$$

$$\begin{matrix}{S}_{2} = {1}^{*} ( {S}_{0} == 1 ) \\ = [ \begin{matrix}1 & 1 & 1 & 0 & 0 & 0 & 1 & 1 & 0 & 1 & \\ 1 & 1 & 0 & 1 & 0 & 1 & 0 & 0 & 0 & 0 & \\ 1 & 0 & 0 & 1 & 0 & 1 & 1 & 0 & 0 & 1 & 1\end{matrix} ]\end{matrix}$$

$$\begin{matrix}T = {S}_{1}^{*} {S}_{2} \\ = [ \begin{matrix}1 & - 1 & - 1 & 0 & 0 & 0 & - 1 & - 1 & 0 & - 1 & \\ 1 & 1 & 0 & - 1 & 0 & 1 & 0 & 0 & 0 & 0 & \\ - 1 & 0 & 0 & 1 & 0 & 1 & 1 & 0 & 0 & 1 & - 1\end{matrix} ]\end{matrix}$$

$${T}_{1} = [ \begin{matrix}1 & - 1 & - 1 & 0 & 0 & 0 & - 1 & - 1 & 0 & - 1 & \\ 1 & 1 & 0 & - 1 & 0 & 1 & 0 & 0 & 0 & 0 & \\ - 1 & 0 & 0 & 1 & 0 & 1 & 1 & 0 & 0 & 1 & - 1\end{matrix} ]$$

$${T}_{2} = [ \begin{matrix}1 & 0 & 1 & 1 & 0 & 0 & 1 & - 1 & 1 & - 1 & \\ - 1 & 0 & 0 & 0 & - 1 & - 1 & 0 & - 1 & 1 & 1 & \\ 0 & - 1 & 0 & 1 & 0 & 0 & 0 & 0 & - 1 & 0 & 0\end{matrix} ]$$

$${T}_{3} = [ \begin{matrix}1 & 0 & 0 & 0 & 0 & - 1 & 0 & 0 & 1 & 0 & \\ 1 & 1 & 0 & 0 & 1 & - 1 & 1 & - 1 & - 1 & 0 & \\ 0 & 0 & - 1 & - 1 & 0 & - 1 & 1 & 1 & 0 & - 1 & 0\end{matrix} ]$$

$${T}_{4} = [ \begin{matrix}- 1 & 0 & - 1 & 1 & 1 & 0 & - 1 & 0 & 1 & 0 & \\ 0 & 0 & 0 & - 1 & 0 & 0 & 1 & 0 & 1 & 1 & \\ 0 & 0 & 1 & - 1 & 1 & - 1 & - 1 & 0 & 0 & 0 & - 1\end{matrix} ]$$

$${C}_{1} = [ \begin{matrix}0 & 1 & - 1 & - 1 & 0 & 0 & 0 & - 1 & - 1 & 0 & \\ - 1 & 1 & 1 & 0 & - 1 & 0 & 1 & 0 & 0 & 0 & 0 \\ - 1 & 0 & 0 & 1 & 0 & 1 & 1 & 0 & 0 & 1 & - 1\end{matrix} ]$$

$${C}_{2} = [ \begin{matrix}0 & 1 & 0 & 1 & 1 & 0 & 0 & 1 & - 1 & 1 & \\ - 1 & - 1 & 0 & 0 & 0 & - 1 & - 1 & 0 & - 1 & 1 & 1 \\ 0 & - 1 & 0 & 1 & 0 & 0 & 0 & 0 & - 1 & 0 & 0\end{matrix} ]$$

$${C}_{3} = [ \begin{matrix}0 & 1 & 0 & 0 & 0 & 0 & - 1 & 0 & 0 & 1 & \\ 0 & 1 & 1 & 0 & 0 & 1 & - 1 & 1 & - 1 & - 1 & 0 \\ 0 & 0 & - 1 & - 1 & 0 & - 1 & 1 & 1 & 0 & - 1 & 0\end{matrix} ]$$

$${C}_{4} = [ \begin{matrix}0 & - 1 & 0 & - 1 & 1 & 1 & 0 & - 1 & 0 & 1 & \\ 0 & 0 & 0 & 0 & - 1 & 0 & 0 & 1 & 0 & 1 & 1 \\ 0 & 0 & 1 & - 1 & 1 & - 1 & - 1 & 0 & 0 & 0 & - 1\end{matrix} ]$$

$$OR$$

$${C}_{1} = [ \begin{matrix}1 & - 1 & - 1 & 0 & 0 & 0 & - 1 & - 1 & 0 & - 1 & \\ 1 & 1 & 0 & - 1 & 0 & 1 & 0 & 0 & 0 & 0 & - 1 \\ 0 & 0 & 1 & 0 & 1 & 1 & 0 & 0 & 1 & - 1 & 0\end{matrix} ]$$

$${C}_{2} = [ \begin{matrix}1 & 0 & 1 & 1 & 0 & 0 & 1 & - 1 & 1 & - 1 & \\ - 1 & 0 & 0 & 0 & - 1 & - 1 & 0 & - 1 & 1 & 1 & 0 \\ - 1 & 0 & 1 & 0 & 0 & 0 & 0 & - 1 & 0 & 0 & 0\end{matrix} ]$$

$${C}_{3} = [ \begin{matrix}1 & 0 & 0 & 0 & 0 & - 1 & 0 & 0 & 1 & 0 & \\ 1 & 1 & 0 & 0 & 1 & - 1 & 1 & - 1 & - 1 & 0 & 0 \\ 0 & - 1 & - 1 & 0 & - 1 & 1 & 1 & 0 & - 1 & 0 & 0\end{matrix} ]$$

$${C}_{4} = [ \begin{matrix}- 1 & 0 & - 1 & 1 & 1 & 0 & - 1 & 0 & 1 & 0 & \\ 0 & 0 & 0 & - 1 & 0 & 0 & 1 & 0 & 1 & 1 & 0 \\ 0 & 1 & - 1 & 1 & - 1 & - 1 & 0 & 0 & 0 & - 1 & 0\end{matrix} ]$$

$${C}^{*} {C}^{′} = \begin{matrix}16 & 0 & 0 & 0 \\ 0 & 16 & 0 & 0 \\ 0 & 0 & 16 & 0 \\ 0 & 0 & 0 & 16.\end{matrix}$$

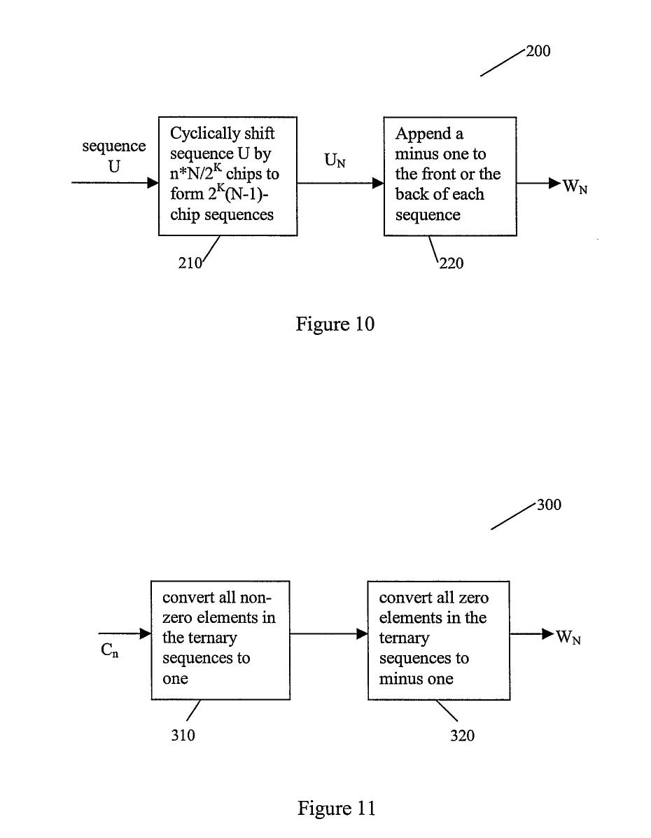

FIG. 10 is a block diagram showing the steps of a method 200 for constructing a set of 2^{K} orthogonal N-chip bipolar sequences to represent a K-bit symbol. First, an (N−1)-chip bipolar base sequence U is chosen. The (N−1)-chip bipolar base sequence U is an M-sequence with a sequence sum equal to 1. The M-sequence is a Maximum-Length Shift-Register Sequence. In step 210, the bipolar base sequence U is cyclically shifted by n*N/2K chips to form 2^{K} (N−1)-chip bipolar sequences Uₙ, where n=1, 2, . . . , 2^{K}. In step 220, minus one (−1) is appended to the front or to the back of each bipolar sequence Uₙ to form the required 2^{K} N-chip bipolar sequences Wₙ, where n=1, 2, . . . , 2^{K}.

In the example given below, the method 200 is implemented using the chosen bipolar base sequence U. The resulting bipolar sequences Uₙ and bipolar sequences Wₙ are shown when K=2 and N=32.

$$U = [ \begin{matrix}1 & 1 & 1 & - 1 & - 1 & - 1 & 1 & 1 & - 1 & 1 & \\ 1 & 1 & - 1 & 1 & - 1 & 1 & - 1 & - 1 & - 1 & - 1 & \\ 1 & - 1 & - 1 & 1 & - 1 & 1 & 1 & - 1 & - 1 & 1 & 1\end{matrix} ]$$

$${U}_{1} = [ \begin{matrix}1 & 1 & 1 & - 1 & - 1 & - 1 & 1 & 1 & - 1 & 1 & \\ 1 & 1 & - 1 & 1 & - 1 & 1 & - 1 & - 1 & - 1 & - 1 & \\ 1 & - 1 & - 1 & 1 & - 1 & 1 & 1 & - 1 & - 1 & 1 & 1\end{matrix} ]$$

$${U}_{2} = [ \begin{matrix}1 & - 1 & 1 & 1 & - 1 & - 1 & 1 & 1 & 1 & 1 & \\ 1 & - 1 & - 1 & - 1 & 1 & 1 & - 1 & 1 & 1 & 1 & \\ - 1 & 1 & - 1 & 1 & - 1 & - 1 & - 1 & - 1 & 1 & - 1 & - 1\end{matrix} ]$$

$${U}_{3} = [ \begin{matrix}1 & - 1 & - 1 & - 1 & - 1 & 1 & - 1 & - 1 & 1 & - 1 & \\ 1 & 1 & - 1 & - 1 & 1 & 1 & 1 & 1 & 1 & - 1 & \\ - 1 & - 1 & 1 & 1 & - 1 & 1 & 1 & 1 & - 1 & 1 & - 1\end{matrix} ]$$

$${U}_{4} = [ \begin{matrix}1 & - 1 & 1 & 1 & 1 & - 1 & 1 & - 1 & 1 & - 1 & \\ - 1 & - 1 & - 1 & 1 & - 1 & - 1 & 1 & - 1 & 1 & 1 & \\ - 1 & - 1 & 1 & 1 & 1 & 1 & 1 & - 1 & - 1 & - 1 & 1\end{matrix} ]$$

$${W}_{1} = [ \begin{matrix}- 1 & 1 & 1 & 1 & - 1 & - 1 & - 1 & 1 & 1 & - 1 & \\ 1 & 1 & 1 & - 1 & 1 & - 1 & 1 & - 1 & - 1 & - 1 & - 1 \\ 1 & - 1 & - 1 & 1 & - 1 & 1 & 1 & - 1 & - 1 & 1 & 1\end{matrix} ]$$

$${W}_{2} = [ \begin{matrix}- 1 & 1 & - 1 & 1 & 1 & - 1 & - 1 & 1 & 1 & 1 & \\ 1 & 1 & - 1 & - 1 & - 1 & 1 & 1 & - 1 & 1 & 1 & 1 \\ - 1 & 1 & - 1 & 1 & - 1 & - 1 & - 1 & - 1 & 1 & - 1 & - 1\end{matrix} ]$$

$${W}_{3} = [ \begin{matrix}- 1 & 1 & - 1 & - 1 & - 1 & - 1 & 1 & - 1 & - 1 & 1 & \\ - 1 & 1 & 1 & - 1 & - 1 & 1 & 1 & 1 & 1 & 1 & - 1 \\ - 1 & - 1 & 1 & 1 & - 1 & 1 & 1 & 1 & - 1 & 1 & - 1\end{matrix} ]$$

$${W}_{4} = [ \begin{matrix}- 1 & 1 & - 1 & 1 & 1 & 1 & - 1 & 1 & - 1 & 1 & \\ - 1 & - 1 & - 1 & - 1 & 1 & - 1 & - 1 & 1 & - 1 & 1 & 1 \\ - 1 & - 1 & 1 & 1 & 1 & 1 & 1 & - 1 & - 1 & - 1 & 1\end{matrix} ]$$

$$OR$$

$${W}_{1} = [ \begin{matrix}1 & 1 & 1 & - 1 & - 1 & - 1 & 1 & 1 & - 1 & 1 & \\ 1 & 1 & - 1 & 1 & - 1 & 1 & - 1 & - 1 & - 1 & - 1 & 1 \\ - 1 & - 1 & 1 & - 1 & 1 & 1 & - 1 & - 1 & 1 & 1 & - 1\end{matrix} ]$$

$${W}_{2} = [ \begin{matrix}1 & - 1 & 1 & 1 & - 1 & - 1 & 1 & 1 & 1 & 1 & \\ 1 & - 1 & - 1 & - 1 & 1 & 1 & - 1 & 1 & 1 & 1 & - 1 \\ 1 & - 1 & 1 & - 1 & - 1 & - 1 & - 1 & 1 & - 1 & - 1 & - 1\end{matrix} ]$$

$${W}_{3} = [ \begin{matrix}1 & - 1 & - 1 & - 1 & - 1 & 1 & - 1 & - 1 & 1 & - 1 & \\ 1 & 1 & - 1 & - 1 & 1 & 1 & 1 & 1 & 1 & - 1 & - 1 \\ - 1 & 1 & 1 & - 1 & 1 & 1 & 1 & - 1 & 1 & - 1 & - 1\end{matrix} ]$$

$${W}_{4} = [ \begin{matrix}1 & - 1 & 1 & 1 & 1 & - 1 & 1 & - 1 & 1 & - 1 & \\ - 1 & - 1 & - 1 & 1 & - 1 & - 1 & 1 & - 1 & 1 & 1 & - 1 \\ - 1 & 1 & 1 & 1 & 1 & 1 & - 1 & - 1 & - 1 & 1 & - 1\end{matrix} ]$$

$${W}^{*} {W}^{′} = \begin{matrix}32 & 0 & 0 & 0 \\ 0 & 32 & 0 & 0 \\ 0 & 0 & 32 & 0 \\ 0 & 0 & 0 & 32.\end{matrix}$$

FIG. 11 is a block diagram showing the steps of a method 300 for converting a set of 2^{K} orthogonal N-chip ternary sequences Cₙ (where n=1, 2, . . . , 2^{K}) to a set of 2^{K} orthogonal N-chip bipolar sequences Wₙ (where n=1, 2, . . . , 2^{K}). This method 300 eliminates the need to store a set of 2^{K} orthogonal N-chip bipolar sequences for transmission. In step 310, all non-zero elements in the set of 2^{K} orthogonal N-chip ternary sequences are converted to one (1). In step 320, all zero elements in the set of 2^{K} orthogonal N-chip ternary sequences are converted to minus one (−1).

In the example given below, method 300 is implemented with K=2 and N=32. The ternary sequences Cₙ are converted to the bipolar sequences Wₙ.

$${C}_{1} = [ \begin{matrix}1 & - 1 & - 1 & 0 & 0 & 0 & - 1 & - 1 & 0 & - 1 & \\ 1 & 1 & 0 & - 1 & 0 & 1 & 0 & 0 & 0 & 0 & - 1 \\ 0 & 0 & 1 & 0 & 1 & 1 & 0 & 0 & 1 & - 1 & 0\end{matrix} ]$$

$${C}_{2} = [ \begin{matrix}1 & 0 & 1 & 1 & 0 & 0 & 1 & - 1 & 1 & - 1 & \\ - 1 & 0 & 0 & 0 & - 1 & - 1 & 0 & - 1 & 1 & 1 & 0 \\ - 1 & 0 & 1 & 0 & 0 & 0 & 0 & - 1 & 0 & 0 & 0\end{matrix} ]$$

$${C}_{3} = [ \begin{matrix}1 & 0 & 0 & 0 & 0 & - 1 & 0 & 0 & 1 & 0 & \\ 1 & 1 & 0 & 0 & 1 & - 1 & 1 & - 1 & - 1 & 0 & 0 \\ 0 & - 1 & - 1 & 0 & - 1 & 1 & 1 & 0 & - 1 & 0 & 0\end{matrix} ]$$

$${C}_{4} = [ \begin{matrix}- 1 & 0 & - 1 & 1 & 1 & 0 & - 1 & 0 & 1 & 0 & \\ 0 & 0 & 0 & - 1 & 0 & 0 & 1 & 0 & 1 & 1 & 0 \\ 0 & 1 & - 1 & 1 & - 1 & - 1 & 0 & 0 & 0 & - 1 & 0\end{matrix} ]$$

$$converted to \text{:}$$

$${W}_{1} = [ \begin{matrix}1 & 1 & 1 & - 1 & - 1 & - 1 & 1 & 1 & - 1 & 1 & \\ 1 & 1 & - 1 & 1 & - 1 & 1 & - 1 & - 1 & - 1 & - 1 & 1 \\ - 1 & - 1 & 1 & - 1 & 1 & 1 & - 1 & - 1 & 1 & 1 & - 1\end{matrix} ]$$

$${W}_{2} = [ \begin{matrix}1 & - 1 & 1 & 1 & - 1 & - 1 & 1 & 1 & 1 & 1 & \\ 1 & - 1 & - 1 & - 1 & 1 & 1 & - 1 & 1 & 1 & 1 & - 1 \\ 1 & - 1 & 1 & - 1 & - 1 & - 1 & - 1 & 1 & - 1 & - 1 & - 1\end{matrix} ]$$

$${W}_{3} = [ \begin{matrix}1 & - 1 & - 1 & - 1 & - 1 & 1 & - 1 & - 1 & 1 & - 1 & \\ 1 & 1 & - 1 & - 1 & 1 & 1 & 1 & 1 & 1 & - 1 & - 1 \\ - 1 & 1 & 1 & - 1 & 1 & 1 & 1 & - 1 & 1 & - 1 & - 1\end{matrix} ]$$

$${W}_{4} = [ \begin{matrix}1 & - 1 & 1 & 1 & 1 & - 1 & 1 & - 1 & 1 & - 1 & \\ - 1 & - 1 & - 1 & 1 & - 1 & - 1 & 1 & - 1 & 1 & 1 & - 1 \\ - 1 & 1 & 1 & 1 & 1 & 1 & - 1 & - 1 & - 1 & 1 & - 1\end{matrix} ]$$

When implementing any of the methods 100, 200, and 300, it is desirable, but not necessary to insure the following properties: Each 2^{K} orthogonal N-chip ternary sequence has equal non-zeros and zeros. There is zero cross-correlation between all of the 2^{K} orthogonal N-chip ternary sequences. Each of the 2^{K} orthogonal N-chip ternary sequences has good autocorrelation properties. There is zero cross-correlation between the ternary and the corresponding binary sequence set. There is near zero cross-correlation between all sequence sets when differential detection is employed.

Methods 100, 200, and 300 can be used to help simplify UWB transmission, reduce the required memory by 50% because the need to store Bipolar sequences is eliminated, and provide a universal code sequence that is compatible with all UWB receiver types with near optimal performance.

We claim:

1. A method for detecting a code sequence in an ultra-wideband system, which comprises:
using an on-off keying detector for detecting a code sequence;
using a soft despreader for despreading an energy of the code sequence to provide a plurality of multipath energies; and
using a RAKE combiner for combining the plurality of multipath energies obtained from the soft despreader.

2. The method according to claim 1, wherein the step of detecting the code sequence includes converting the code sequence to a binary code sequence.

3. The method according to claim 1, wherein the code sequence is a ternary orthogonal code sequence.

4. The method according to claim 3, wherein the step of detecting the code sequence includes converting the code sequence to a binary code sequence.

5. The method according to claim 1, wherein the code sequence is a ternary orthogonal code sequence with time hopping.

6. The method according to claim 5, wherein the step of detecting the code sequence includes converting the code sequence to a binary code sequence.

7. The method according to claim 1, wherein the on-off keying detector is a non-coherent on-off keying receiver.

8. The method according to claim 7, wherein the step of detecting the code sequence includes converting the code sequence to a binary code sequence.

9. The method according to claim 7, wherein the non-coherent on-off keying detector includes a square law device, an integrator, and an analog-to-digital converter.

10. The method according to claim 9, wherein the step of detecting the code sequence includes converting the code sequence to a binary code sequence.

11. The method according to claim 1, wherein the soft despreader is a binary sequence soft despreader.

12. A system for detecting a code sequence in an ultra-wideband system, which comprises:
an on-off keying detector for detecting a code sequence;
a soft despreader for despreading an energy of the code sequence to provide a plurality of multipath energies; and
a RAKE combiner for combining the plurality of multipath energies obtained from the soft despreader.

13. The system according to claim 12, wherein the code sequence is a ternary orthogonal code sequence.

14. The system according to claim 12, wherein the code sequence is a ternary orthogonal code sequence with time hopping.

15. The system according to claim 12, wherein the on-off keying detector is a non-coherent on-off keying detector.

16. The system according to claim 15, wherein the non-coherent on-off keying detector includes a square law device, an integrator, and an analog-to-digital converter.

17. The system according to claim 12, wherein the on-off keying detector converts the code sequence to a binary code sequence.

18. The system according to claim 12, wherein the soft despreader is a binary sequence soft despreader.
